(19) United States
(12) Patent Application Publication
(10) Pub. No.: US 2016/0343521 A1
(43) Pub. Date: Nov. 24, 2016

(54) HOLDER FOR VACUUM TUBE OF ON-LOAD TAP CHANGER

(71) Applicant: MASCHINENFABRIK REINHAUSEN GMBH, Regensburg (DE)

(72) Inventors: Stefan HEROLD, Regensburg (DE); Gregor WILHELM, Regensburg (DE)

(21) Appl. No.: 15/108,628

(22) PCT Filed: Jan. 20, 2015
(86) PCT No.: PCT/EP2015/050921

§ 371 Date: Jun. 28, 2016

(30) Foreign Application Priority Data
Feb. 12, 2014 (DE) 10 2014 101 746.3

(51) Int. Cl. H01H 9/00; H01H 33/662

(52) U.S. Cl. CPC H01H 9/0038; H01H 33/662; H01H 2009/0083

(57) ABSTRACT

A holder (10) for at least one vacuum switching tube (11) of an on-load tap changer comprises:
a base plate (12) that can be fastened to a frame of the on-load tap changer;
a first sleeve (13), into which a first vacuum switching tube can be inserted, and that has two oppositely positioned ends, of which an outer end (16) that is remote from the base plate (12), can be connected with this vacuum switching tube (11), and an inner end (17) that is close to the base plate (12), is connected with the base plate (12);
wherein:
the first sleeve (13) completely surrounds or encloses at least a part of the first vacuum switching tube (11) or has a section (18) that completely surrounds or encloses at least a part of the first vacuum switching tube (11).

The invention relates to a holder for at least one vacuum switching tube of an on-load tap changer.

In known on-load tap changers, the vacuum switching tubes are mounted between two base plates. In a three-phase on-load tap changer, the base plates, for example, are subdivided into three equal sectors, and four vacuum switching tubes for each phase are arranged in one of the sectors. Operation of the vacuum switching tubes is carried out by a cam mechanism, for example, and it involves high forces and corresponding tensions and deformations of the base plates. The deformations occurring in the respective sector when operating a vacuum switching tube are thus transmitted to the other sectors and to the associated vacuum switching tubes. Complex and tolerance-sensitive support frame constructions are required in order to be able to ensure a robust bearing and operation of the vacuum switching tubes.

The object of the invention is to simplify the bearing of vacuum switching tubes in an on-load tap changer.

This object is achieved by a holder according to the independent claims. Advantageous developments and embodiments of the invention are described in the dependent claims.

The invention relates to a holder for at least one vacuum switching tube of an on-load tap changer, comprising:
a base plate that can be fastened to or arranged on a frame of the on-load tap changer;
a first shell or sleeve, into which a first vacuum switching tube can be inserted, and that has two oppositely positioned ends, of which an outer end that is remote from the base plate, can be connected with this vacuum switching tube, and an inner end that is close to the base plate, is connected with the base plate;

where:
the first sleeve completely surrounds or encloses at least a part of the first vacuum switching tube that is properly inserted into this sleeve, or it at least has a section that completely surrounds or encloses at least a part of the first vacuum switching tube that is properly inserted into this sleeve.

Since the vacuum switching tubes are connected to only one base plate, an interaction between the vacuum switching tubes of different sectors is prevented. The proposed holder thus enables a simple and stable bearing of the vacuum switching tubes.

Due to a shorter tolerance chain between the fixed switch contact and the movable switch contact of the vacuum switching tube, tolerance influence is moreover considerably reduced by accommodating the vacuum switching tubes in sleeves.

The proposed holder additionally enables easier assembly and disassembly of the vacuum switching tubes.

The proposed holder can be formed in any manner as required, for example, in a tubular design and/or in a cage-like design, and/or it can comprise at least one additional or further sleeve.

The inner end of the sleeve can be connected with the base plate in any manner as required and can be fastened to the base plate, for example.

Each sleeve can be formed in any manner as required and can be electrically non-conductive or electrically insulating, for example, and/or it can be produced from plastic, for example.

It can be provided that the section borders on or adjoins the inner end or contains the inner end.

It can be provided that the base plate has a throughgoing hole that is aligned with the sleeve.

It can be provided that the free end of the movable switch contact of the vacuum switching tube that is properly inserted into the sleeve is positioned in the throughgoing hole

It can be provided that the edge at the outer end runs or is bent radially inward and that it can support itself against a surface of the vacuum switching tube that is properly inserted into the sleeve with the surface of the vacuum switching tube being turned away from the base plate.

It can be provided that the outer end of the sleeve can be connected with an outer end of the vacuum switching tube, at which end the fixed switch contact of the vacuum switching tube extends through to the outside.

It can be provided that the outer end of the vacuum switching tube can be connected with the free end of the fixed switch contact of the vacuum switching tube.

It can be provided that the holder comprises:
a cover that bears on the outer end of the first sleeve with a surface facing toward the base plate and that can be connected with the free end of the fixed switch contact of the first vacuum switching tube.

The cover can be formed in any manner as required and can be electrically conductive, for example, and/or it can be produced from copper, for example.

It can be provided that the holder comprises:
a second sleeve, into which a second vacuum switching tube can be inserted, and that has two oppositely positioned ends, of which an outer end that is remote from the base plate, can be connected with this vacuum switching tube, and an inner end that is close to the base plate, is connected with the base plate;

where:
the second sleeve completely surrounds or encloses at least a part of the second vacuum switching tube that is properly inserted into this sleeve, or it at least has a section that completely surrounds or encloses at least a part of the second vacuum switching tube that is properly inserted into this sleeve;
the first sleeve and the second sleeve extend parallel next to each other and fixedly connected with each other.

The second sleeve can be formed in any manner as required, for example, analogous or corresponding to the first sleeve.

The sleeves can be connected with each other in any manner as required, and they can be fastened to each other or in one piece, for example.

It can be provided that the cover bears on the outer end of the second sleeve with a surface facing toward the base plate, and that it can be connected with the free end of the fixed switch contact of the second vacuum switching tube.

It can be provided that the cover is electrically conductive.

In this way, the free ends of the fixed switch contacts of the two vacuum switching tubes can be connected electrically conductively with each other.

It can be provided that the cover and/or each sleeve has at least one ventilation opening.

The ventilation openings prevent that air remains in the sleeves when filling transformer oil into an oil transformer that has an on-load tap changer with one of the proposed holders.

In the following, embodiments of the invention are explained in detail with reference to the attached drawings. The individual features thereof are, however, not limited to the individual embodiments but can be connected and/or combined with individual features described further above and/or with individual features of other embodiments. Each example in the illustrations is provided by way of explanation, not limitation of the invention. The reference characters included in the claims are by no means intended to limit the scope of protection, but rather merely refer to the embodiments shown in the figures, in which:

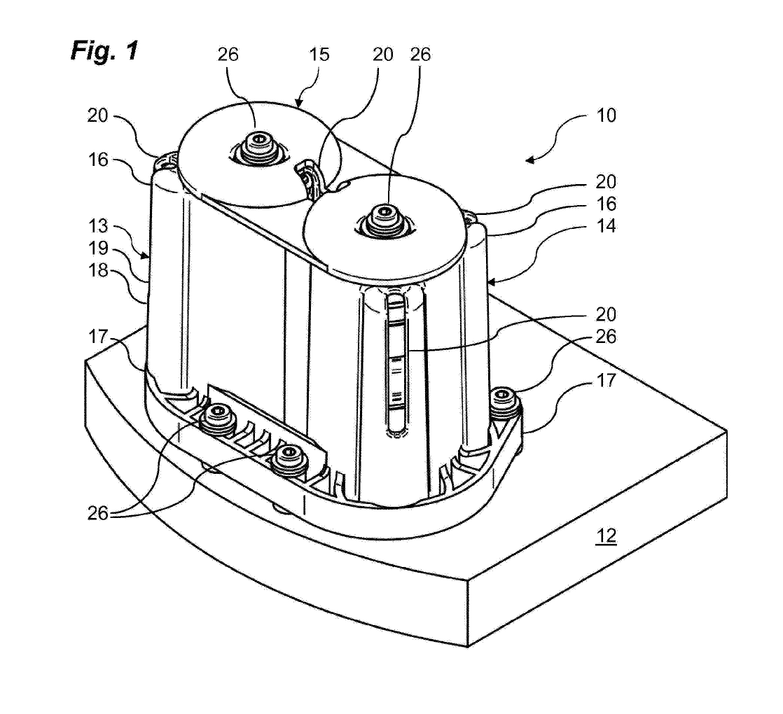

FIG. 1 is a perspective view from diagonally above of a preferred embodiment of a holder for at least one vacuum switching tube of an on-load tap changer;

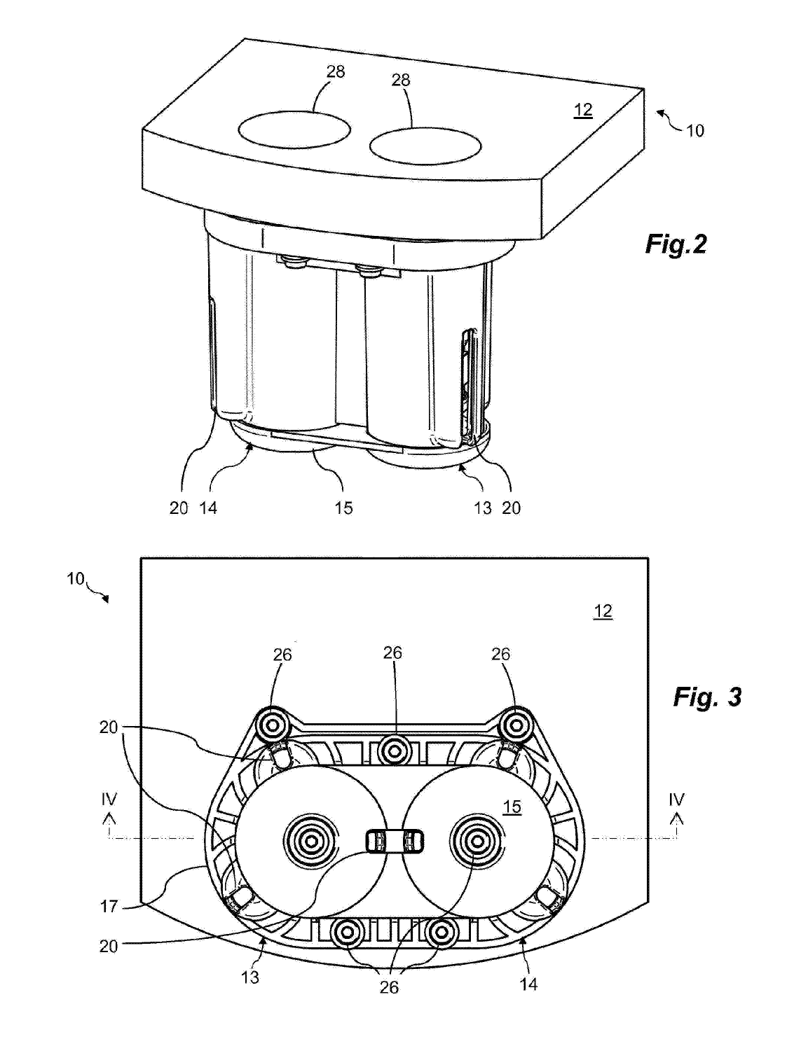

FIG. 2 is a perspective view from diagonally below for FIG. 1;

FIG. 3 is a top view for FIG. 1;

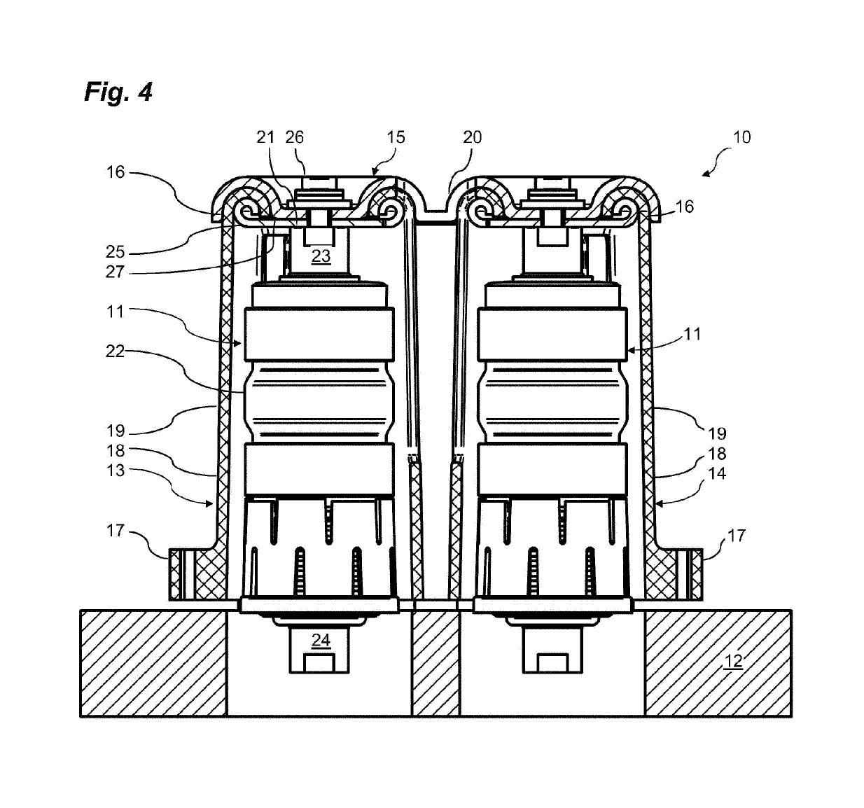

FIG. 4 is a section along the line IV-IV of FIG. 3.

FIGS. 1 to 4 schematically illustrate a preferred embodiment of a holder 10 for at least one vacuum switching tube 11 of an on-load tap changer that is not shown here. The holder 10 in this instance is exemplarily formed for two vacuum switching tubes 11 that are properly inserted into the holder 10 and fastened to it.

The holder 10 in this embodiment comprises a base plate 12 that can be fastened to a frame of the on-load tap changer, which frame is not shown here, and it comprises a first sleeve 13, into which a first vacuum switching tube 11—on the left side in FIG. 1—can be inserted, and a second sleeve 14, into which a second vacuum switching tube 11—on the right side in FIG. 1—can be inserted, and a cover 15.

The sleeves 13, 14 are here exemplarily mirror-symmetric to each other, formed to be essentially tubular, and arranged parallel next to each other. They are electrically non-conductive or electrically insulating and they are fixedly connected with each other by being produced in one piece by injection molding from an electrically insulating plastic. They each have two opposite ends 16, 17, particularly one outer end 16 that is remote from the base plate 12, and that can be connected with respective associated vacuum switching tube 11, and an inner end 17 that is close to the base plate 12, and that is connected with the base plate 12.

Each sleeve 13, 14 has a first section 18 that completely surrounds or encloses a part—in FIG. 1 the lower part—of the associated vacuum switching tube 11 and here exemplarily contains the inner end 17. Each sleeve 13, 14 moreover has a second section 19 that here exemplarily borders onto the first section 18 on the one side and onto the outer end 16 on the other side, and that has two slit-shaped ventilation openings 20. The second section 19 thus surrounds or encloses a part—in FIG. 1 the upper part—of the associated vacuum switching tube 11, although, due to these ventilation openings 20, not completely, but rather partially.

Each sleeve 13, 14 has the edge at its outer end 16 bent or folded over or curved radially inward and can support itself against a surface 21 of the associated vacuum switching tube 11, which surface 21 is turned away from the base plate 12 and from the inner end 17. Each vacuum switching tube 11 comprises a vacuum vessel 22, a fixed switch contact having a contact element—not illustrated here—in the vacuum vessel 22 and, fastened to the contact element, a fixed metal shaft 23 that is led out of the vacuum vessel 22; and a movable switch contact having a contact element—not illustrated here—in the vacuum vessel 22 and, fastened to the contact element, a movable metal shaft 24 that is led out of the vacuum vessel 22. The surface 21 here exemplarily is the end face 21 of the fixed metal shaft 23, which end face 21 is turned away from the vacuum vessel 22. Positioned between this surface 21 and the radially inwardly bent edge at the outer end 16 is an electrically conductive perforated disk 25 that is fastened to the fixed metal shaft 23 with a screw 26. For each sleeve 13, 14 the outer end 16 is thus connected with an outer end of the associated vacuum switching tube 11, at which outer end the fixed switch contact extends through to the outside by the fixed metal shaft 23, and connected with the free end of the fixed switch contact, particularly, with the end face of the fixed metal shaft 23.

With a surface 27 facing toward the base plate 12, the cover 15 bears on the radially inwardly bent edges of the outer ends 16 of the sleeves 13, 14 and on the end faces 21 of the fixed metal shafts 23 of the vacuum switching tubes 11 and is thus connected with the free end of the fixed switch contacts.

The cover 15 consists of copper and is thus electrically conductive. With the screws 26 positioned in the fixed metal shafts 23, the cover 15 is pressed against the perforated disks 25 and the fixed metal shafts 23 and is thus connected electrically conductively with the fixed switch contacts.

The cover 15 also has a ventilation opening 20.

Each sleeve 13, 14 has the edge at its inner end 17 bent or folded over or curved flange-like radially outward and fastened to the base plate 12 with screws 26.

For each sleeve 13, 14 the base plate 12 has a throughgoing hole 28 that is aligned with the associated sleeve 13, 14 and in which the free end of the movable metal shaft 24 and thus of the movable switch contact of the associated vacuum switching tube 11 is positioned. An operating device—not illustrated here—for the vacuum switching tube 11, for example a cam mechanism, can be coupled with this free end.

Reference characters

| | |
|---|---|
| 10 | Holder |
| 11 | Vacuum switching tube |
| 12 | Base plate |
| 13 | First sleeve |
| 14 | Second sleeve |
| 15 | Cover |
| 16 | Outer end of 13, 14 |
| 17 | Inner end of 13, 14 |
| 18 | First section of 13, 14 |
| 19 | Second section of 13, 14 |
| 20 | Ventilation openings |
| 21 | End face of 23 |
| 22 | Vacuum vessel |
| 23 | Fixed metal shaft |
| 24 | Movable metal shaft |
| 25 | Perforated disk |
| 26 | Screw |
| 27 | Surface of 15 |
| 28 | Throughgoing hole |

1. A holder (10) for at least one vacuum switching tube (11) of an on-load tap changer, comprising:
a base plate (12) that can be fastened to a frame of the on-load tap changer;
a first sleeve (13), into which a first vacuum switching tube (11) can be inserted, and that has two oppositely positioned ends, of which an outer end (16) that is remote from the base plate (12) can be connected with this vacuum switching tube (11), and an inner end (17) that is close to the base plate (12) is connected with the base plate (12);
wherein:
the first sleeve (13) completely surrounds or encloses at least a part of the first vacuum switching tube (11) or has a section (18) that completely surrounds or encloses at least a part of the first vacuum switching tube (11).

2. The holder (10) according to the previous claim wherein:
the section (18) borders on or adjoins the inner end (17) or forms the inner end (17).

3. The holder (10) according to one of the previous claims wherein:
the base plate (12) has a throughgoing hole (28) that is aligned with the sleeve (13).

4. The holder (10) according to the previous claim wherein:
the free end of the movable switch contact (24) of the vacuum switching tube (11) is positioned in the throughgoing hole (28).

5. The holder (10) according to one of the previous claims wherein:
the edge at the outer end (16) is bent radially inward and can support itself against a surface of the vacuum switching tube (11), which surface is turned away from the base plate (12).

6. The holder (10) according to one of the previous claims wherein:
the outer end (16) can be connected with an outer end (21) of the vacuum switching tube (11), at which end (21) the fixed switch contact (23) of the vacuum switching tube (11) extends through to the outside.

7. The holder (10) according to one of the previous claims wherein:
the outer end (16) can be connected with the free end (21) of the fixed switch contact (23) of the vacuum switching tube (11).

8. The holder (10) according to one of the previous claims comprising:
a cover (15) that bears on the outer end (16) of the first sleeve (13) with a surface facing toward the base plate (12), and that can be connected with the free end (21) of the fixed switch contact (23) of the first vacuum switching tube (11).

9. The holder (10) according to one of the previous claims comprising:
a second sleeve (14), into which a second vacuum switching tube (11) can be inserted, and that has two oppositely positioned ends, of which an outer end (16) that is remote from the base plate (12), can be connected with this vacuum switching tube (11), and an inner end (17) that is close to the base plate (12), is connected with the base plate (12);
wherein:
the second sleeve (14) completely surrounds or encloses at least a part of the second vacuum switching tube (11) or has a section (18) that completely surrounds or encloses at least a part of the second vacuum switching tube (11);
the first sleeve and the second sleeve (13, 14) extend parallel next to each other and are fixedly connected with each other.

10. The holder (10) according to the previous claim and to the claim preceding the previous claim wherein:
the cover (15) bears on the outer end (16) of the second sleeve (14) with a surface facing toward the base plate (12) and can be connected with the free end (21) of the fixed switch contact (23) of the second vacuum switching tube (11).

11. The holder (10) according to the previous claim wherein:
the cover (15) is electrically conductive.
